(19) United States
(12) Patent Application Publication
(10) Pub. No.: US 2008/0240456 A1
(43) Pub. Date: Oct. 2, 2008

(54) ACTIVE NOISE CONTROL APPARATUS

(75) Inventors: Kosuke Sakamoto, Wako-shi (JP); Toshio Inoue, Wako-shi (JP); Akira Takahashi, Wako-shi (JP); Yasunori Kobayashi, Wako-shi (JP); Kenji Yamagata, Kawagoe-shi (JP); Shinji Fukumoto, Kawagoe-shi (JP); Noriyuki Hirasawa, Kawagoe-shi (JP); Koji Suzuki, Kawagoe-shi (JP)

Correspondence Address: RANKIN, HILL & CLARK LLP, 38210 Glenn Avenue, WILLOUGHBY, OH, 44094-7808, US

(73) Assignees: HONDA MOTOR CO., LTD., Tokyo (JP); PIONEER CORPORATION, Tokyo (JP)

(21) Appl. No.: 12/058,061

(22) Filed: Mar. 28, 2008

(30) Foreign Application Priority Data
Mar. 30, 2007 (JP) 2007-091446

(51) Int. Cl. G10K 11/16

(52) U.S. Cl. 381/71.4

(57) ABSTRACT

A control characteristics changing unit reads, from an EEPROM, various control parameters in an ANC electronic controller, which correspond to specification information acquired from ECUs. The control characteristics changing unit then outputs control parameters, depending on changed specification information among the read control parameters, as change signals Sm1 through Sm6 to a basic signal generating unit, reference signal generating units, filter coefficient updating units, corrective signal generating units, switches, and variable-gain amplifiers, respectively.

### BACKGROUND OF THE INVENTION

1. Field of the Invention

The present invention relates to an active noise control apparatus for reducing an in-compartment noise caused by vibratory noise generated by a vibratory noise source in a vehicle, with a cancellation sound which is in opposite phase to the in-compartment noise.

2. Description of the Related Art

Heretofore, it has been known in the art that when an engine, which forms a vibratory noise source in a vehicle, burns an air-fuel mixture, it produces a vibratory noise due to fluctuations in the rotational speed of the output shaft of the engine, and an in-compartment noise is generated by the vibratory noise. It has been proposed to apply an active noise control apparatus (hereinafter referred to as “ANC”) to the vehicle for generating a control signal for canceling out the in-compartment noise, based on an engine rotation signal and depending on the rotation of the output shaft which is correlated to the in-compartment noise, and radiating a canceling sound based on the control signal from speakers into the compartment in order to reduce an in-compartment noise level at the position of the ears of passengers in the compartment. The frequency of the vibratory noise varies depending on the number of cylinders of the engine. Japanese Laid-Open Patent Publication No. 8-76772 discloses an active silencer apparatus for changing the frequency of the control signal depending on the number of cylinders of the engine.

Vehicles of one type are available in various combinations according to different specifications. If different combinations (hereinafter referred to as “specification differences”) affect the control characteristics of the ANC for generating the control signal, then the control characteristics need to be changed depending on the specification differences, so as to provide optimum silencing capability.

The specification differences represent information about compartment spatial configurations depending on whether the vehicle is a four-door vehicle or a two-door vehicle, information about engine types depending on whether the engine is a V-shaped 6-cylinder engine (V6 engine) or an in-line 4-cylinder engine (L4 engine), information about the number of cylinders and displacement of the engine for reducing an in-compartment noise (muffled sound) due to the vibratory noise of the engine, or information about drive types of the vehicle, including two-wheel drive types such as FF, FR, RR, or MR or a four-wheel drive type such as 4WD, for reducing an in-compartment noise generated from the vibratory noise source of the drive system while the vehicle is running.

If the ANC of the same control characteristics is applied to a vehicle having different specifications without concern over the specification differences, then the desired control capability (silencing capability) of the ANC is not available.

The control characteristics can be changed by adjusting input and output gains of the ANC and other control parameters thereof depending on the specification differences. However, such a change is not enough for apparently determining whether the ANC that has been changed depending on the specification differences is a changed ANC or not. As a result, an ANC which is different from the ANC that has been changed depending on the specification differences may possibly be assembled in error on the vehicle.

Therefore, when the control characteristics of an ANC, which are changed depending on the specification differences, are changed after the ANC is manufactured, the changed ANC needs to be separately managed in order to prevent erroneous assembly thereof. Therefore, extra man-hours and costs are required to manage the ANC.

### SUMMARY OF THE INVENTION

It is an object of the present invention to provide an active noise control apparatus which provides greater versatility, which can be prevented from being assembled erroneously in a vehicle, and which can be managed with reduced man-hours and costs, while preventing deterioration of its silencing capability for reducing an in-compartment noise.

An active noise control apparatus (ANC) according to the present invention comprises a control signal generator for generating a control signal for canceling out an in-compartment noise caused by a vibratory noise generated by a vibratory noise source in a vehicle, based on the frequency of the vibratory noise, a sound outputting device for outputting a canceling sound based on the control signal into a passenger compartment of the vehicle, and a sound detector for detecting a canceling error sound between the in-compartment noise and the canceling sound and outputting an error signal based on the detected canceling error sound to the control signal generator, wherein the control signal generator comprises a control characteristics changing unit for acquiring specification information, concerning specifications of a spatial configuration of the passenger compartment and/or specifications of the vibratory noise source, from a plurality of electronic control units (ECUs) installed in the vehicle, and changing control characteristics of the control signal generator for generating the control signal to control characteristics corresponding to the acquired specification information.

With the above arrangement, if there are several specification differences available for a vehicle of one type, then the control characteristics changing unit changes the control characteristics (the control parameters) depending on the specification information from the ECUs. Therefore, it is unnecessary to manufacture different ANCs depending on the specification differences, or to change the control characteristics of the ANC before the ANC is installed in the vehicle. Thus, the ANC has greater versatility, can be prevented from being assembled erroneously on the vehicle, and can be managed with reduced man-hours and costs, while preventing deterioration in the control capability (silencing capability) thereof.

Even if the specification information is changed, the control characteristics can be changed depending on the changed specification information. Accordingly, the silencing control ability of the ANC is stable, regardless of specification differences. Specifically, if the specification information is information of low reliability, then the control characteristics may be changed in order to cause the ANC to stop generating control signals, or changed to cause the ANC to operate with a lower silencing capability. Consequently, the ANC has a failsafe design.

According to the present invention, therefore, even if the specification information is changed, the ANC maintains an optimum silencing capability for the changed specification information.

The control characteristics refer to various control parameters, which are required in order for the control signal generator to generate control signals.

The specification information represents different combinations of various specifications (specification differences) of one type of vehicle, which is output from the ECUs disposed in the vehicle through a CAN (Controller Area Network) to the ANC.

Specifically, the specification information includes, for example, specification information from a door lock ECU representing spatial configurations of the passenger compartment and indicative of whether the vehicle is a four-door vehicle or a two-door vehicle, specification information from an engine control ECU for controlling an engine, which forms the vibratory noise source, representing engine types and indicative of whether the engine is a V6 engine or an L4 engine, specification information from the engine control ECU representing the number of active cylinders of the engine, specification information from the engine control ECU representing drive types (i.e., two-wheel drive types such as FF, FR, RR, or MR or a four-wheel drive type such as 4WD) of the vehicle, specification information from a transmission ECU for controlling the transmission, which also forms the vibratory noise source, representing transmission types (i.e., a manual transmission (MT) or an automatic transmission (AT)).

The control signal generator may comprise a basic signal generator for generating a basic signal having a control frequency based on the frequency of the vibratory noise, an adaptive filter for generating the control signal based on the basic signal, a reference signal generator for correcting the basic signal based on a corrective value, depending on signal transfer characteristics from the sound outputting device to the sound detector, and outputting the corrected basic signal as a reference signal, and a filter coefficient updating unit for updating a filter coefficient of the adaptive filter in order to minimize the error signal based on the error signal and the reference signal, wherein, based on the specification information, the control characteristics changing unit should preferably change at least one of a step size parameter for updating the filter coefficient, a range of the control frequency, and the corrective value.

Even if the specification information is changed, the control characteristics changing unit changes various control parameters, including the step size parameter, the control frequency range, and the corrective value, so as to keep an optimum silencing capability.

The control signal generator may further comprise a corrective signal generator for generating a corrective signal by multiplying the reference signal by the filter coefficient and a predetermined constant, and an adder for generating a corrective error signal by adding the corrective signal to the error signal, and outputting the corrective error signal to the filter coefficient updating unit. The filter coefficient updating unit should preferably update the filter coefficient of the adaptive filter in order to minimize the corrective error signal based on the corrective error signal and the reference signal, and wherein the control characteristics changing unit should preferably change the constant based on the specification information.

The corrective signal is a signal produced by multiplying the basic signal by the corrective value, and further multiplying the product (the reference signal) by the filter coefficient and a constant. Further, the corrective signal is a signal produced by multiplying, by a constant, a quasi-control signal depending on the canceling sound that is propagated from the sound outputting device to the sound detector. By changing the constant depending on the specification information, the filter coefficient updating unit can be supplied with a corrective error signal, which is optimum for updating the filter coefficient and thereby optimizing the control signal.

The control signal generator should further comprise an error signal amplifier for amplifying the error signal from the sound detector and outputting the amplified error signal, and a control signal amplifier for amplifying the control signal from the adaptive filter and outputting the amplified control signal to the sound outputting device. The control characteristics changing unit preferably changes the amplification factors of the error signal amplifier and the control signal amplifier based on the specification information.

Therefore, depending on the changed specification information, the sound outputting device can be supplied with a control signal having an optimum signal level, or the filter coefficient updating unit can be supplied with an error signal having an optimum signal level, thereby further increasing the silencing capability of the ANC.

If the basic signal generator generates the basic signal having the control frequency that is a harmonic of a predetermined degree with respect to the frequency of the vibratory noise, then the control characteristics changing unit preferably changes the degree based on the specification information.

Therefore, even if the specification information is changed, the degree is changed depending on the changed specification information, thereby generating a basic signal that is optimum for reducing in-compartment noise.

The sound detector may comprise a plurality of sound detectors disposed in the passenger compartment. The control signal generator preferably comprises a switching unit for switching the sound detectors for outputting the error signal. The control characteristics changing unit preferably controls the switching unit based on the specification information, so as to switch the sound detectors for outputting the error signal.

Therefore, even if the specification information is changed, the in-compartment noise located about the ears of a passenger in the passenger compartment can reliably be reduced.

The ANC may further comprise a control characteristics memory for storing in advance control characteristics corresponding to the specification information from the ECUs. When the control characteristics changing unit acquires the specification information, the control characteristics changing unit preferably reads the control characteristics corresponding to the acquired specification information from the control characteristics memory, and changes the control characteristics set in the control signal generator to the read control characteristics.

Therefore, even if the specification information is changed, the control characteristics can simply be changed.

The control characteristics changing unit may include a buffer for storing specification information acquired from the ECUs, wherein the control characteristics changing unit compares present specification information acquired from the ECUs with preceding specification information stored in the buffer, and changes the control characteristics if there is a change between the present specification information and the preceding specification information.

Therefore, even if the specification information is changed, the control characteristics can efficiently be changed.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram showing an arrangement of an ANC according to an embodiment of the present invention;

FIG. 2 is a side elevational view, partly in block form, of a vehicle in which the ANC shown in FIG. 1 is installed;

FIG. 3 is a schematic plan view of the vehicle shown in FIG. 2;

FIG. 4 is a block diagram of the ANC shown in FIG. 1, the signal transfer characteristics of which are measured by a signal transfer characteristics measuring device;

FIG. 5 is a side elevational view, partly in block form, of the vehicle, illustrating a silencing control process for silencing in-compartment noise according to a control mode A;

FIG. 6 is a block diagram, partly omitted from illustration, illustrating the silencing control process for silencing in-compartment noise according to the control mode A;

FIG. 7 is a side elevational view, partly in block form, of the vehicle, illustrating a silencing control process for silencing in-compartment noise according to a control mode B;

FIG. 8 is a block diagram, partly omitted from illustration, illustrating the silencing control process for silencing in-compartment noise according to the control mode B;

FIG. 9 is a side elevational view, partly in block form, of the vehicle, illustrating a silencing control process for silencing in-compartment noise according to a control mode C;

FIG. 10 is a block diagram, partly omitted from illustration, illustrating the silencing control process for silencing in-compartment noise according to the control mode C;

FIG. 11 is a table showing specification information and control parameters stored in an EEPROM shown in FIG. 1;

FIG. 12 is a table showing specification information and control parameters stored in an EEPROM shown in FIG. 1; and

FIG. 13 is a flowchart of an operation sequence for the control characteristics changing unit shown in FIG. 1.

### DESCRIPTION OF THE PREFERRED EMBODIMENTS

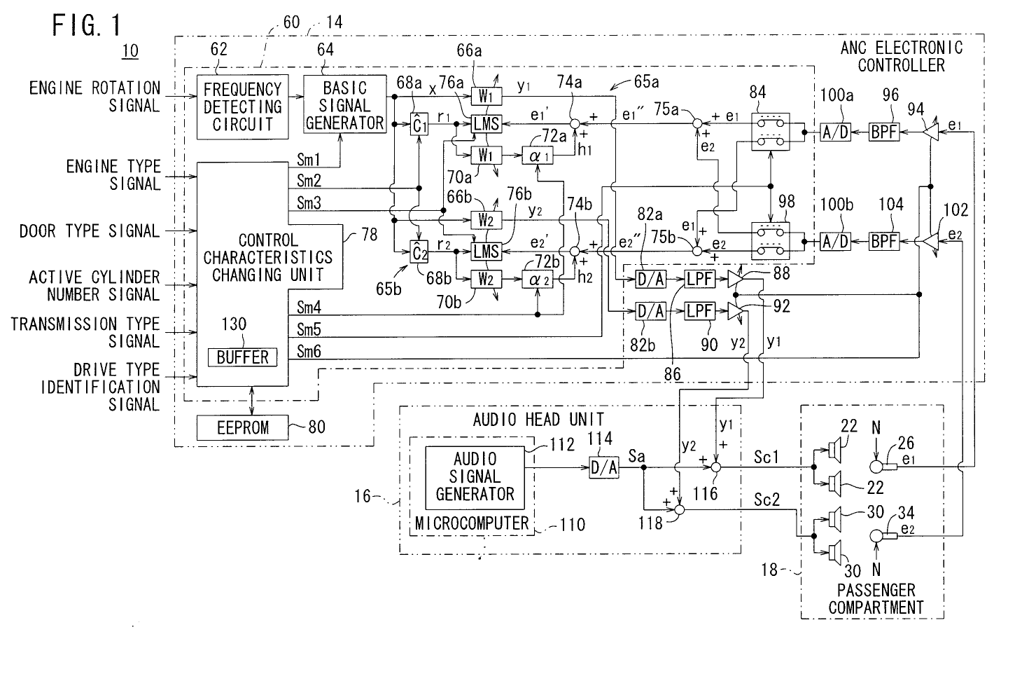

An active noise control apparatus (ANC) 10 according to the present invention, which is applied to reduce in-compartment noise in the passenger compartment 18 of a vehicle 12, shall be described below with reference to FIGS. 1 through 13.

As shown in FIGS. 1 through 3, the ANC 10 comprises an ANC electronic controller (control signal generator) 14 for generating control signals y1, y2 for canceling out in-compartment noise, speakers (sound outputting devices) 22, 30 for supplying combined signals Sc1, Sc2 which represent combinations of the control signals y1, y2 and an audio signal Sa generated by an audio head unit 16, so as to output sounds (sounds representing combinations of musical sound based on the audio signal Sa and canceling sounds based on the control signals y1, y2) into the passenger compartment 18, and microphones (sound detectors) 26, 34 for detecting error sounds between the canceling sounds and the in-compartment noise, and outputting error signals e1, e2 representing the detected error sounds to the ANC electronic controller 14.

The speakers 22, 30 are mounted as standard audio units in the vehicle 12. The speakers 22 are disposed on respective left and right doors, not shown, of the vehicle 12 near the front seats 20, and the speakers 30 are disposed behind respective headrests 32 of the rear seats 28. The microphone 26 is disposed in a roof lining of the vehicle 12, near head rests 24 of the front seats 20 in the passenger compartment 18, or more specifically, near the position of a left ear 144 of the passenger 140 on the right front seat 20 and in an intermediate position between the front seats 20. The microphone 34 is disposed in a roof lining of the vehicle 12 in an intermediate position between the headrests 32.

As shown in FIG. 1, the ANC 10 comprises a microcomputer 60, an EEPROM (control characteristics memory) 80, D/A converters 82a, 82b, A/D converters 100a, 100b, low-pass filters (LPFs) 86, 90, bandpass filters (BPFs) 96, 104, variable-gain amplifiers (control signal amplifiers) 88, 92, and variable-gain amplifiers (error signal amplifiers) 94, 102.

Functionally, the microcomputer 60 comprises a frequency detecting circuit 62, a basic signal generator 64, control signal generators 65a, 65b, adders 75a, 75b, switches (switching units) 84, 98, and a control characteristics changing unit 78. The control signal generator 65a comprises adaptive filters 66a, 70a, a reference signal generator 68a, a filter coefficient updating unit 76a, a corrective signal generator 72a, and an adder 74a. The control signal generator 65b comprises adaptive filters 66b, 70b, a reference signal generator 68b, a filter coefficient updating unit 76b, a corrective signal generator 72b, and an adder 74b.

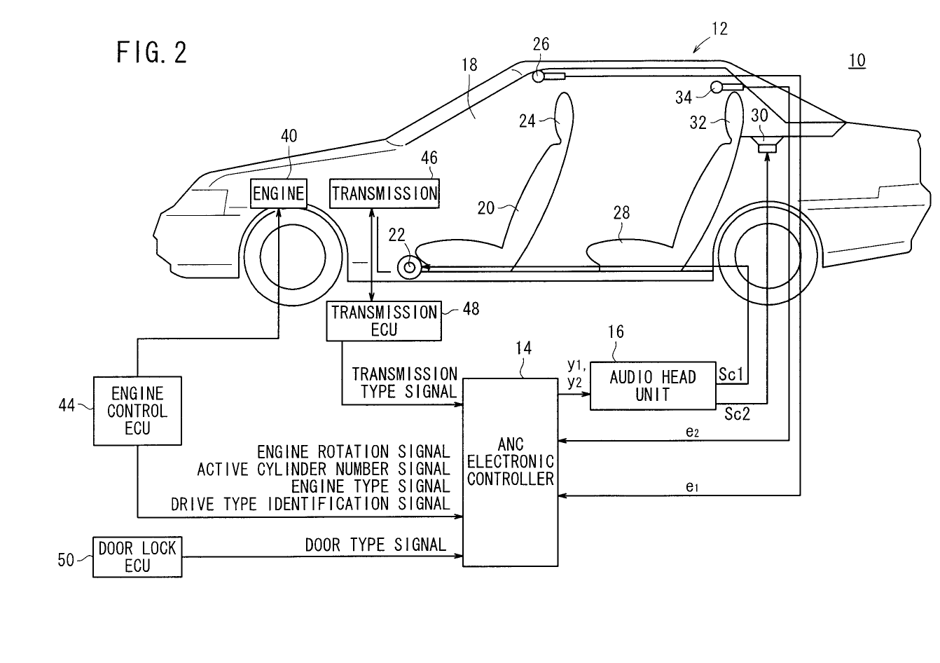

The frequency detecting circuit 62 comprises a frequency counter for detecting the frequency of an engine rotation signal output from an engine control ECU 44 that controls an engine 40 (see FIG. 2), which acts as a vibratory noise source. The engine rotation signal is a signal that is output in synchronism with rotation of the output shaft of the engine 40, and is correlated to the noise generated by the engine 40 (e.g., an engine sound and a periodic noise caused by vibratory forces produced upon rotation of the output shaft of the engine 40) as well as to vibratory noise representative of vibrations of the engine 40.

The basic signal generator 64 generates a basic signal x having a given harmonic with respect to the frequency from the frequency detecting circuit 62, which serves as a fundamental frequency.

The adaptive filter 66a generates a signal W1·x by multiplying the basic signal x by a filter coefficient W1. The signal W1·x is converted by the D/A converter 82a from a digital signal into an analog signal, which passes through the LPF 86 and is amplified by the variable-gain amplifier 88 into the control signal y1, for canceling out noise in the passenger compartment 18 (in-compartment noise) caused by vibratory noise generated by the engine 40. The control signal y1 is output from the variable-gain amplifier 88 to the audio head unit 16. The adaptive filter 66b generates a signal W2·x by multiplying the basic signal x by a filter coefficient W2. The signal W2·x is converted by the D/A converter 82b from a digital signal into an analog signal, which passes through the LPF 90 and is amplified by the variable-gain amplifier 92 into the control signal y2, for canceling out the in-compartment noise. The control signal y2 is output from the variable-gain amplifier 92 to the audio head unit 16.

The audio head unit 16 operates as follows: The audio signal Sa generated by an audio signal generator 112 in the microcomputer 110 is converted by a D/A converter 114 from a digital signal into an analog signal, which is output to adders 116, 118. The adder 116 adds the control signal y1 to the audio signal Sa so as to generate a combined signal Sc1, which is output to the speakers 22. The adder 118 adds the control signal y2 to the audio signal Sa so as to generate a combined signal Sc2, which is output to the speakers 30.

Each of the speakers 22 outputs sounds into the passenger compartment 18 based on the combined signal Sc1. Each of the speakers 30 outputs sounds into the passenger compartment 18 based on the combined signal Sc2. As described above, since the combined signal Sc1 represents a combination of the control signal y1 and the audio signal Sa, whereas the combined signal Sc2 represents a combination of the control signal y2 and the audio signal Sa, the speakers 22, 30 output canceling sounds into the passenger compartment 18 based on the control signals y1, y2, while also outputting music sounds into the passenger compartment 18 based on the audio signal Sa.

If the ANC electronic controller 14 does not output the control signals y1, y2 to the audio head unit 16, each of the speakers 22, 30 outputs only music sounds into the passenger compartment 18 based on the audio signal Sa.

The microphone 26 detects an error sound between the in-compartment noise at the position thereof and the canceling sound from each of the speakers 22 and/or each of the speakers 30, and the microphone 26 outputs an error signal e1 to the ANC electronic controller 14 representing the detected error sound. The microphone 34 detects an error sound between the in-compartment noise at the position thereof and the canceling sound from each of the speakers 22 and/or each of the speakers 30, and the microphone 34 outputs an error signal e2 to the ANC electronic controller 14 representing the detected error sound.

The error signal e1 is amplified by the variable-gain amplifier 94 in the ANC electronic controller 14 and then passes through the BPF 96. The error signal e1 is then converted by the A/D converter 100a from an analog signal into a digital signal, which is output to the microcomputer 60. The error signal e2 is amplified by the variable-gain amplifier 102 in the ANC electronic controller 14 and then passes through the BPF 104. The error signal e2 is then converted by the A/D converter 100b from an analog signal into a digital signal, which is output to the microcomputer 60.

In the microcomputer 60, the switches 84, 98, which are essentially identical in arrangement to each other, constitute switches for changing the connections between the A/D converters 100a, 100b and the adders 75a, 75b. Specifically, the switch 84 either connects the A/D converter 100a and the adder 75a to each other while outputting the error signal e1 to the adder 75a, or connects the A/D converter 100a and the adder 75b to each other while outputting the error signal e1 to the adder 75b. The switch 98 either connects the A/D converter 100b and the adder 75a to each other while outputting the error signal e2 to the adder 75a, or connects the A/D converter 100b and the adder 75b to each other while outputting the error signal e2 to the adder 75b.

The adder 75a combines the error signal e1 from the switch 84 and/or the error signal e2 from the switch 98 and outputs the combined signal as an error signal e1″ to the adder 74a. The adder 75b combines the error signal e1 from the switch 84 and/or the error signal e2 from the switch 98 and outputs the combined signal as an error signal e2″ to the adder 74b.

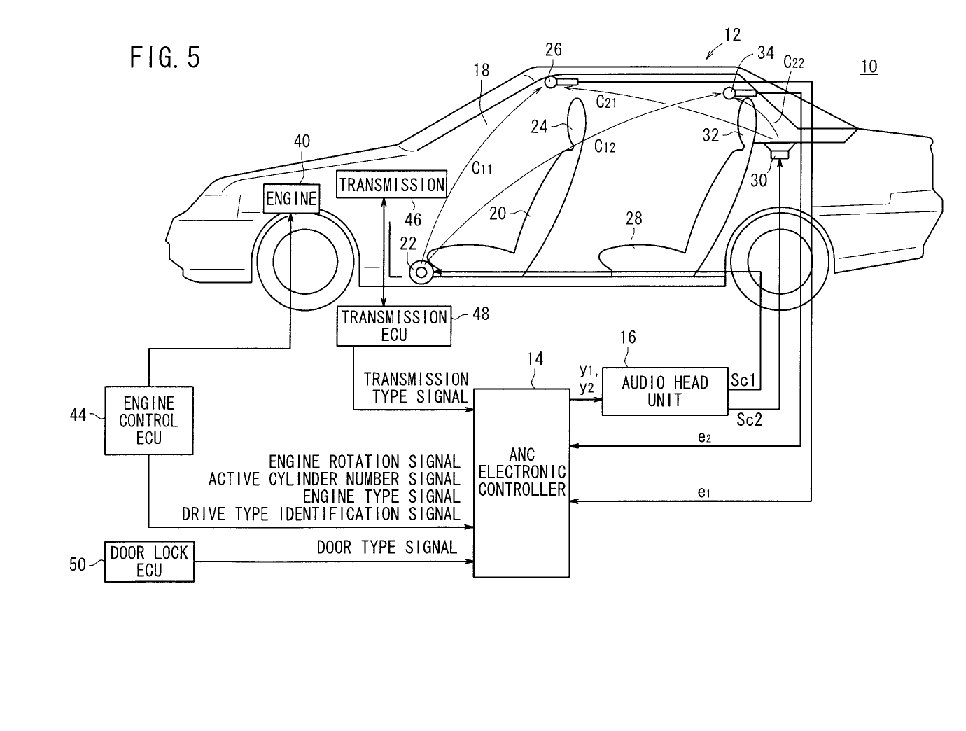

Corrective values Ĉ11 through Ĉ22, which are indicative of signal transfer characteristics C11 through C22 (see FIGS. 5 through 10) from the speakers 22, 30 to the microphones 26, 34, are set as a corrective value Ĉ1 in the reference signal generator 68a. The reference signal generator 68a corrects the basic signal x with the corrective value Ĉ1 so as to generate a reference signal r1, and outputs the reference signal r1 to the filter coefficient updating unit 76a and the adaptive filter 70a. The corrective values Ĉ11 through Ĉ22 also are set as a corrective value Ĉ2 in the reference signal generator 68b. The reference signal generator 68b corrects the basic signal x with the corrective value Ĉ2 so as to generate a reference signal r2, and outputs the reference signal r2 to the filter coefficient updating unit 76b and the adaptive filter 70b.

The signal transfer characteristic C11 refers to a signal transfer characteristic from each of the speakers 22 to the microphone 26, and the signal transfer characteristic C12 refers to a signal transfer characteristic from each of the speakers 22 to the microphone 34. The signal transfer characteristic C21 refers to a signal transfer characteristic from each of the speakers 30 to the microphone 26, and the signal transfer characteristic C22 refers to a signal transfer characteristic from each of the speakers 30 to the microphone 34.

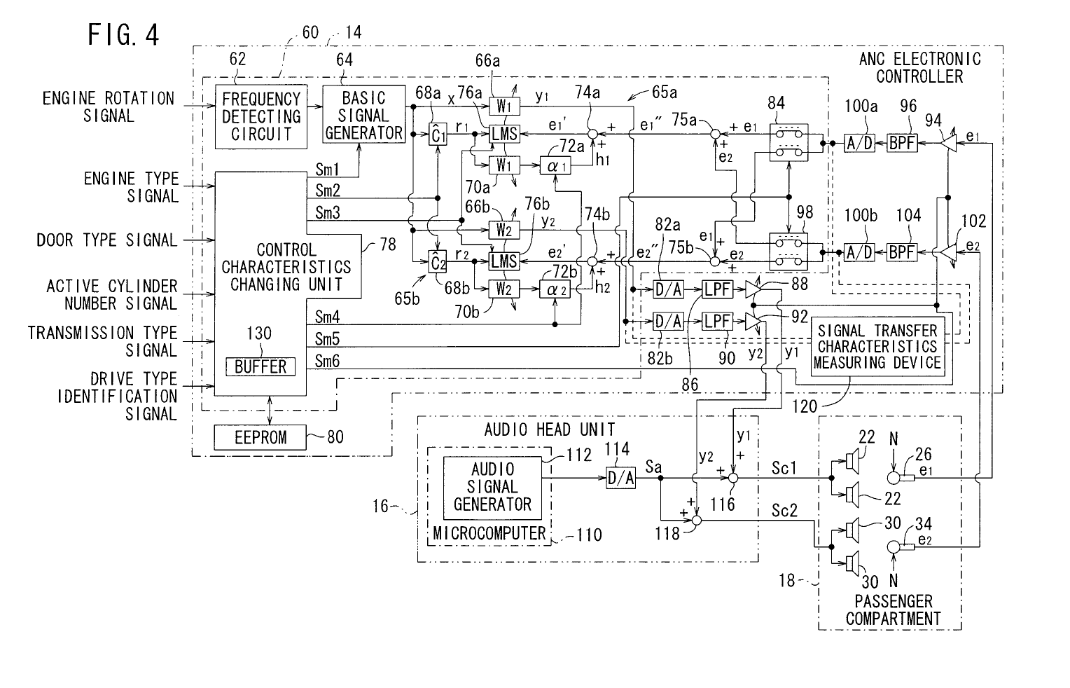

The signal transfer characteristics are actually measured as follows: As shown in FIG. 4, a signal transfer characteristics measuring device 120, which comprises a Fourier transforming device, is connected between the input terminal of the D/A converter 82a or the D/A converter 82b and the output terminal of the A/D converter 100a or the A/D converter 100b, as indicated by the broken lines. The signal transfer characteristics measuring device 120 measures signal transfer characteristics based on a test signal input from the adaptive filter 66a or the adaptive filter 66b of the microcomputer 60 to the D/A converter 82a or the D/A converter 82b, and a signal output from A/D converter 100a or the A/D converter 100b to the switch 84 or the switch 98 of the microcomputer 60. The signal transfer characteristics measured by the signal transfer characteristics measuring device 120 are set as corrective values Ĉ1, Ĉ2 in the reference signal generators 68a, 68b.

Depending on how the signal transfer characteristics measuring device 120 measures the signal transfer characteristics, the corrective values Ĉ1, Ĉ2 may represent the signal transfer characteristics C11 through C22 from the speakers 22, 30 to the microphones 26, 34, or the corrective values Ĉ11 through Ĉ22 indicative of signal transfer characteristics including the signal transfer characteristics C11 through C22, from the output terminal of the adaptive filter 66a or the adaptive filter 66b to the input terminal of the switch 84 or the switch 98, measured as described above.

The adaptive filter 70a, which is identical in arrangement to the adaptive filter 66a, generates a signal r1·W1 by multiplying the reference signal r1(=Ĉ1·x) by the filter coefficient W1, and outputs the signal r1·W1 to the corrective signal generator 72a. The corrective signal generator 72a generates a corrective signal h1(=α1·Ĉ1·x1·W1) by multiplying the signal r1·W1·(=Ĉ1·x1·W1) from the adaptive filter 70a by a predetermined constant α1, and then outputs the corrective signal h1 to the adder 74a. The adder 74a adds the error signal e1″ from the adder 74a to the corrective signal h1, thereby generating a corrective error signal e1′(=e1″+h1), and outputs the corrective error signal e1′ to the filter coefficient updating unit 76a.

The adaptive filter 70b, which is identical in arrangement to the adaptive filter 66b, generates a signal r2·W2 by multiplying the reference signal r2(=Ĉ2·x) by the filter coefficient W2, and outputs the signal r2·W2 to the corrective signal generator 72b. The corrective signal generator 72b generates a corrective signal h2(=α2·Ĉ2·x2·W2) by multiplying the signal r2·W2(=Ĉ2·x2·W2) from the adaptive filter 70b by a predetermined constant α2, and then outputs the corrective signal h2 to the adder 74b. The adder 74b adds the error signal e2″ from the adder 74b to the corrective signal h2, thereby generating a corrective error signal e2′(=e2″+h2), and outputs the corrective error signal e2′ to the filter coefficient updating unit 76b.

Within the corrective signal h1, a signal component Ĉ1·x1·W1 is a quasi-control signal y1′ depending on the canceling sounds propagated from the speakers 22, 30 to the microphones 26, 34. Therefore, the corrective signal h1 represents a signal (h1=α1·y1′) produced by multiplying the estimated quasi-control signal y1′ by the constant α1. Within the corrective signal h2, a signal component Ĉ2·x2·W2 is also a quasi-control signal y2′ depending on the canceling sounds propagated from the speakers 22, 30 to the microphones 26, 34. Therefore, the corrective signal h2 represents a signal (h2=α2·y2′) produced by multiplying the estimated quasi-control signal y2′ by the constant α2. Accordingly, the error signals e1″, e2″ may be considered as combined signals (e1″=y1′+N, e2″=y2′+N), which represent combinations of the quasi-control signals y1′, y2′ and a noise signal N depending on the in-compartment noise.

If a sampling event at a given time is represented by n in the microcomputer 60, then a corrective error signal e1′(n) is expressed according to equation (1) shown below. The level of the corrective error signal e1′(n) can be changed by changing the constant α1.

$$\begin{matrix}e {1}^{′} ( n ) = e {1}^{″} ( n ) + h 1 ( n ) \\ = \{ y {1}^{′} ( n ) + N ( n ) \} + α 1 \cdot y {1}^{′} ( n ) \\ = N ( n ) + ( 1 + α1 ) \cdot y {1}^{′} ( n ) \\ = N ( n ) + ( 1 + α1 ) \cdot \hat{C} 1 \cdot x 1 \cdot W 1\end{matrix} \qquad ( 1 )$$

A corrective error signal e2′(n) is expressed according to equation (2) shown below. The level of the corrective error signal e2′(n) can be changed by changing the constant α2.

$$\begin{matrix}e {2}^{′} ( n ) = e {2}^{″} ( n ) + h 2 ( n ) \\ = \{ y {2}^{′} ( n ) + N ( n ) \} + α 2 \cdot y {2}^{′} ( n ) \\ = N ( n ) + ( 1 + α2 ) \cdot y {2}^{′} ( n ) \\ = N ( n ) + ( 1 + α2 ) \cdot \hat{C} 2 \cdot x 2 \cdot W \end{matrix} \qquad ( 2 )$$

The filter coefficient updating unit 76a, which comprises a least mean square algorithm (LMS) operator, performs an adaptive arithmetic process for adaptively calculating the filter coefficient W1 based on the reference signal r1 and the corrective error signal e1′, i.e., an arithmetic process for calculating the filter coefficient W1 according to a least mean square method in order to minimize the corrective error signal e1′. The filter coefficient updating unit 76a successively updates the filter coefficient W1 based on the calculated result. Similarly, the filter coefficient updating unit 76b, which comprises a least mean square algorithm (LMS) operator, performs an adaptive arithmetic process for adaptively calculating the filter coefficient W2 based on the reference signal r2 and the corrective error signal e2′, i.e., an arithmetic process for calculating the filter coefficient W2 according to a least mean square method in order to minimize the corrective error signal e2′. The filter coefficient updating unit 76b successively updates the filter coefficient W2 based on the calculated result.

Specifically, the filter coefficient W1 is updated according to equation (3) shown below in the filter coefficient updating unit 76a, whereas the filter coefficient W2 is updated according to equation (4) shown below in the filter coefficient updating unit 76b.

W1(n+1)=W1(n)−μ1·e1′(n)·r1(n) (3)

W2(n+1)=W2(n)−μ2·e2′(n)·r2(n) (4)

where μ1, μ2 represent step size parameters.

As described above, the filter coefficient updating units 76a, 76b update the filter coefficients W1(n+1), W2(n+1) such that the corrective error signals e1′, e2′ will become nil. If e1′=0 in the equation (1), then y1′(n) can be expressed according to equation (5) shown below. The level of y1′(n) can be changed by adjusting α1 depending on N(n).

y1′(n)=−N(n)/(1+α1) (5)

If e2′=0 in equation (2), then y2′(n) also can be expressed according to equation (6) shown below. The level of y2′(n) can be changed by adjusting α2 depending on N(n).

y2′(n)=−N(n)/(1+α2) (6)

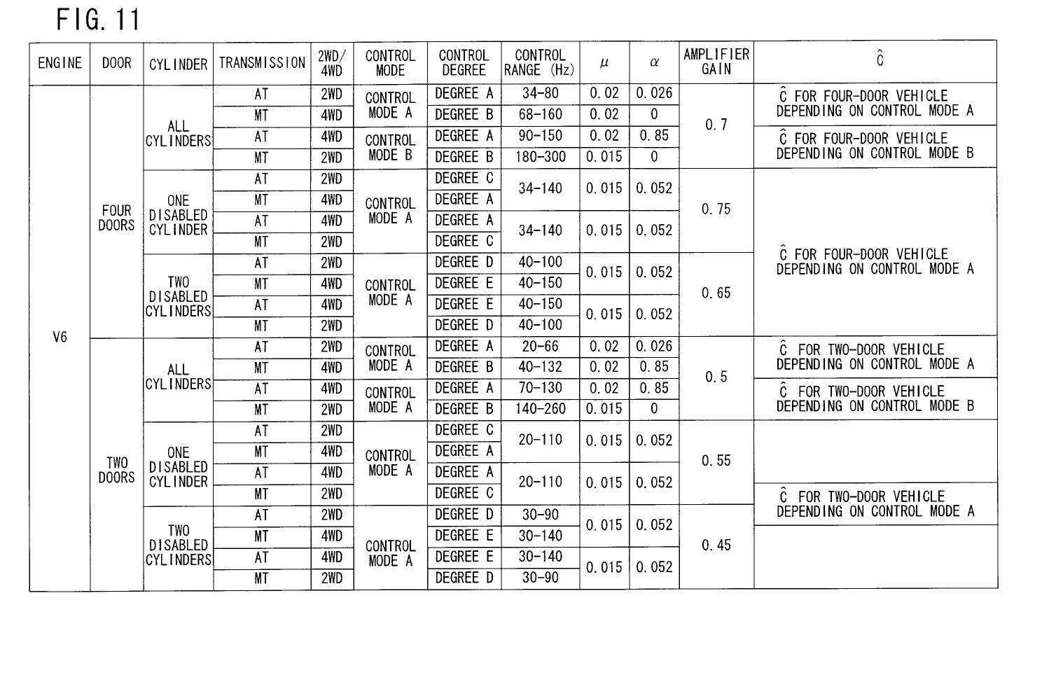

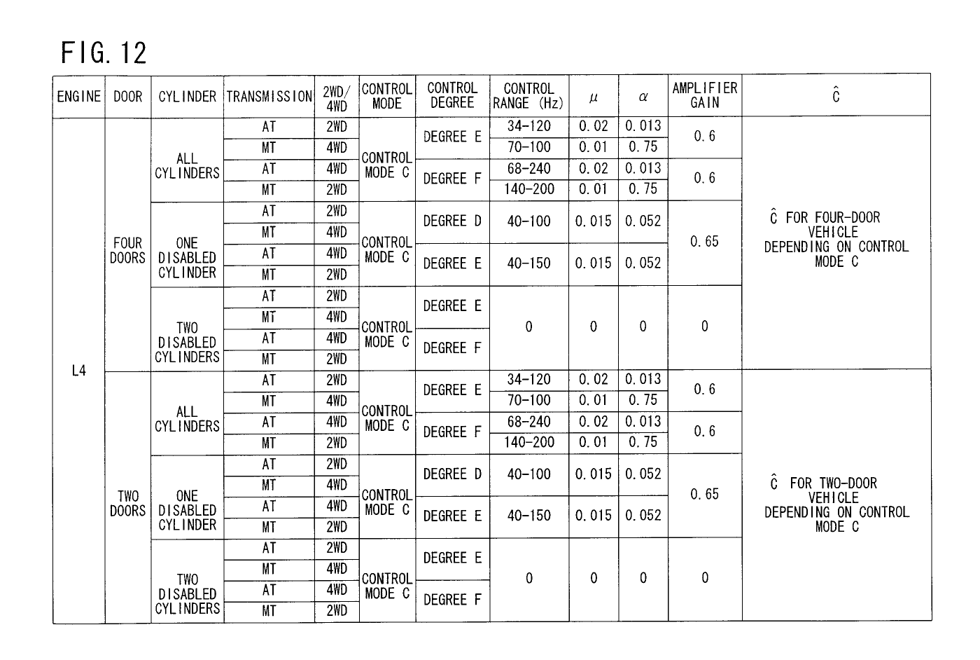

The control characteristics changing unit 78 acquires specification information from the engine control ECU 44 concerning specifications of spatial configurations of the passenger compartment 18, a transmission ECU 48, and a door lock ECU 50, which are installed in the passenger compartment 12, and/or specifications of the vibratory noise source such as the engine 40 or the like. Based on the acquired specification information, the control characteristics changing unit 78 then reads control characteristics for generating the control signals y1, y2 from the tables shown in FIGS. 11 and 12, which are stored in the EEPROM 80, and changes the control characteristics in the ANC electronic controller 14 into control characteristics corresponding to the specification information, using the control characteristics read from the EEPROM 80.

The control characteristics refer to various control parameters in the ANC electronic controller 14, which are required to generate the control signals y1, y2.

Specifically, as indicated by the tables shown in FIGS. 11 and 12, which are stored in the EEPROM 80, the control parameters include (1) the control signal generators 65a, 65b for outputting the control signals y1, y2, together with the combinations of connections made between the A/D converters 100a, 100b and the adders 75a, 75b by the switches 84, 98 (control modes A through C appearing in the control methods column shown in FIGS. 11 and 12), (2) the degrees (degrees A through F appearing in the control degrees column shown in FIGS. 11 and 12) of frequencies (control frequencies) of the basic signal x with respect to the frequency of the engine rotation signal in the basic signal generator 64, (3) the ranges of control frequencies (frequency ranges appearing in the control ranges column shown in FIGS. 11 and 12) of the control signals y1, y2 in the ANC electronic controller 14, (4) step size parameters μ1, μ2 (numerical values appearing in the μ column shown in FIGS. 11 and 12), (5) constants α1, α2 (numerical values appearing in the α column shown in FIGS. 11 and 12), (6) amplification factors (numerical values appearing in the amplifier gain column shown in FIGS. 11 and 12) of the variable-gain amplifiers 88, 92, 94, 102, and (7) corrective values Ĉ1, Ĉ2 (appearing in the Ĉ column shown in FIGS. 11 and 12).

The control modes A through C will be described in detail below. The control modes A through C represent silencing control processes employing different combinations between the speakers 22, 30 for outputting canceling sounds and the microphones 26, 34 for detecting error sounds, based on the connection combinations described in item (1) above (see FIGS. 5 through 10).

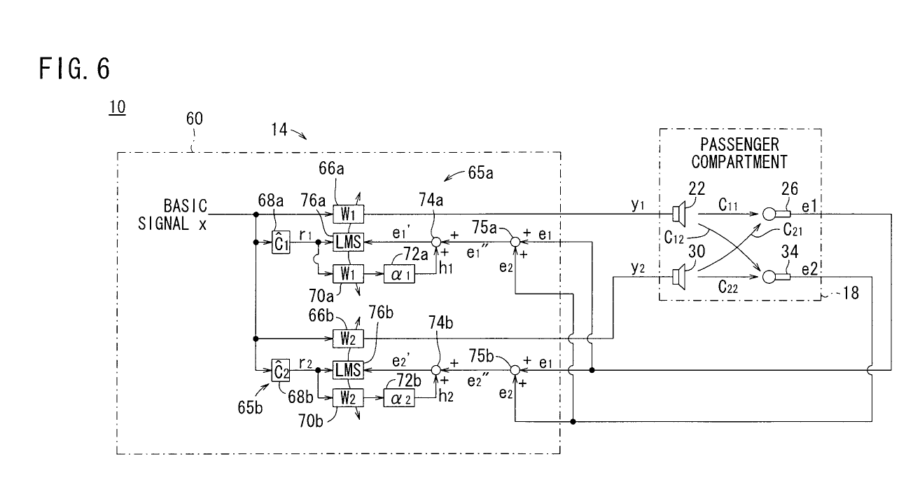

In FIGS. 6, 8 and 10, for facilitating understanding of the present invention, the frequency detecting circuit 62, the basic signal generator 64, the control characteristics changing unit 78, the EEPROM 80, the D/A converters 82a, 82b, the LPFs 86, 90, the variable-gain amplifiers 88, 92, 94, 102, the audio head unit 16, the BPFs 96, 104, the A/D converters 100a, 100b, and the switches 84, 98 have been omitted from illustration. Also, only one of each of the speakers 22, 30 is illustrated.

In the control mode A, as shown in FIGS. 5 and 6, the control signal y1 is supplied to the speaker 22 so as to enable the speaker 22 to output canceling sounds into the passenger compartment 18, and the control signal y2 is supplied to the speaker 30 so as to enable the speaker 30 to output canceling sounds into the passenger compartment 18. The microphone 26 outputs an error sound signal between the canceling sounds from the speakers 22, 30 and the in-compartment noise, as an error signal e1, to the ANC electronic controller 14. The microphone 34 outputs an error sound signal between the canceling sounds from the speakers 22, 30 and the in-compartment noise, as an error signal e2, to the ANC electronic controller 14.

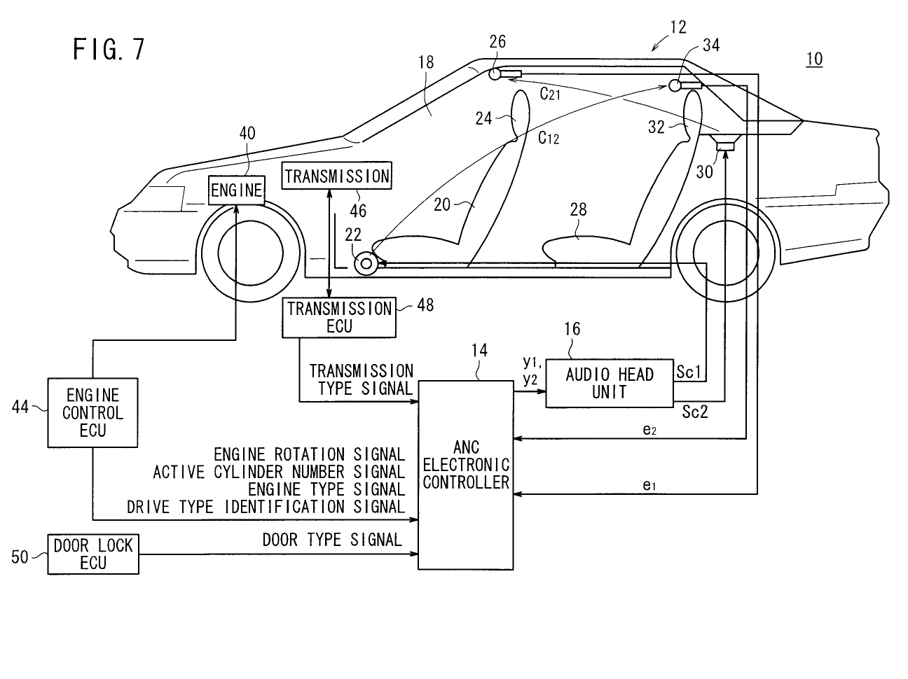

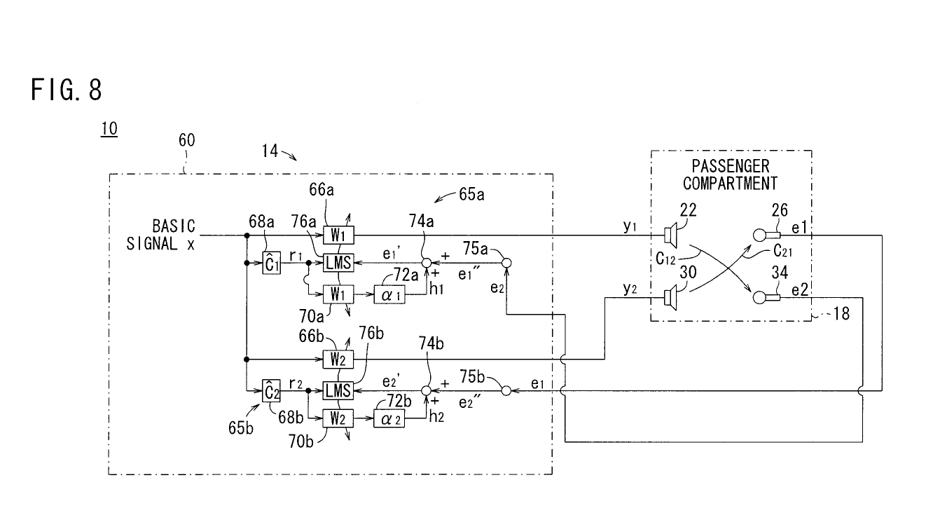

In the control mode B, as shown in FIGS. 7 and 8, the control signal y1 is supplied to the speaker 22 so as to enable the speaker 22 to output canceling sounds into the passenger compartment 18, and the microphone 34 outputs an error sound signal between the canceling sounds from the speaker 22 and the in-compartment noise, as an error signal e2, to the ANC electronic controller 14. The control signal y2 is supplied to the speaker 30 so as to enable the speaker 30 to output canceling sounds into the passenger compartment 18, and the microphone 26 outputs an error sound signal between the canceling sounds from the speaker 30 and the in-compartment noise, as an error signal e1, to the ANC electronic controller 14.

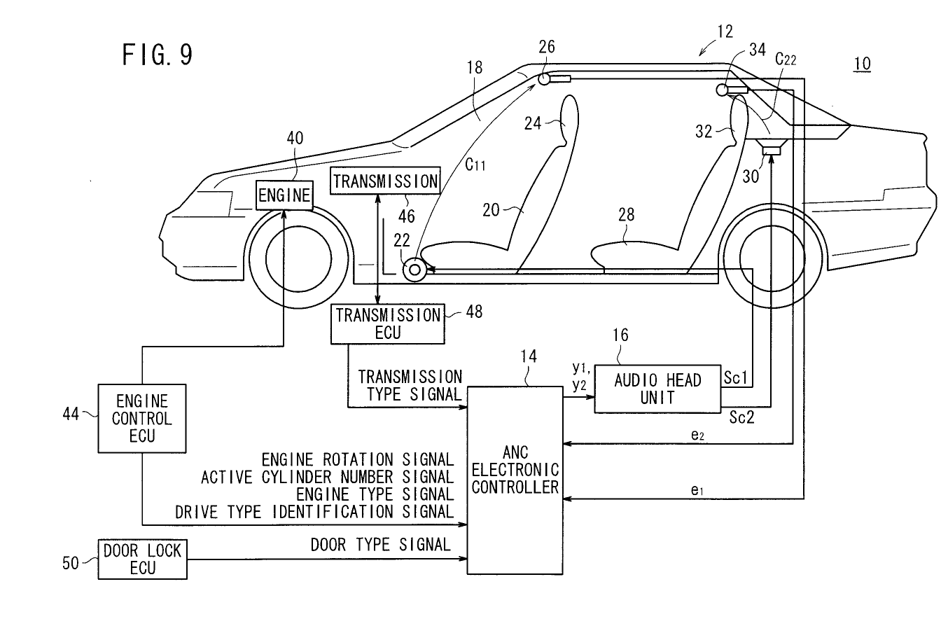

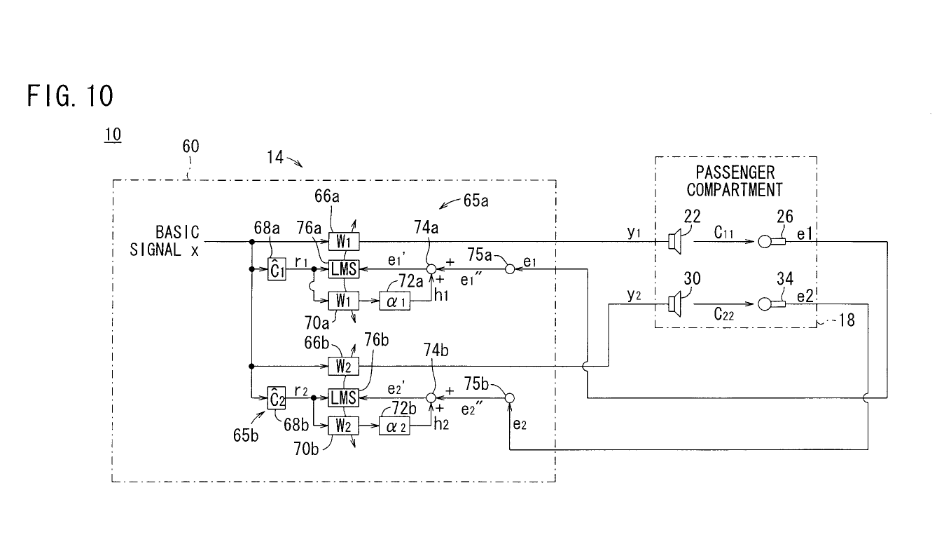

In the control mode C, as shown in FIGS. 9 and 10, the control signal y1 is supplied to the speaker 22 so as to enable the speaker 22 to output canceling sounds into the passenger compartment 18, and the microphone 26 outputs an error sound signal between the canceling sounds from the speaker 22 and the in-compartment noise, as an error signal e1, to the ANC electronic controller 14. The control signal y2 is supplied to the speaker 30 so as to enable the speaker 30 to output canceling sounds into the passenger compartment 18, and the microphone 34 outputs an error sound signal between the canceling sound from the speaker 30 and the in-compartment noise, as an error signal e2, to the ANC electronic controller 14.

Usually, the in-compartment noise is silenced in the control mode A (see FIGS. 5 and 6). It is also possible to switch to the control mode B (see FIGS. 7 and 8), or to the control mode C (see FIGS. 9 and 10), for silencing the in-compartment noise.

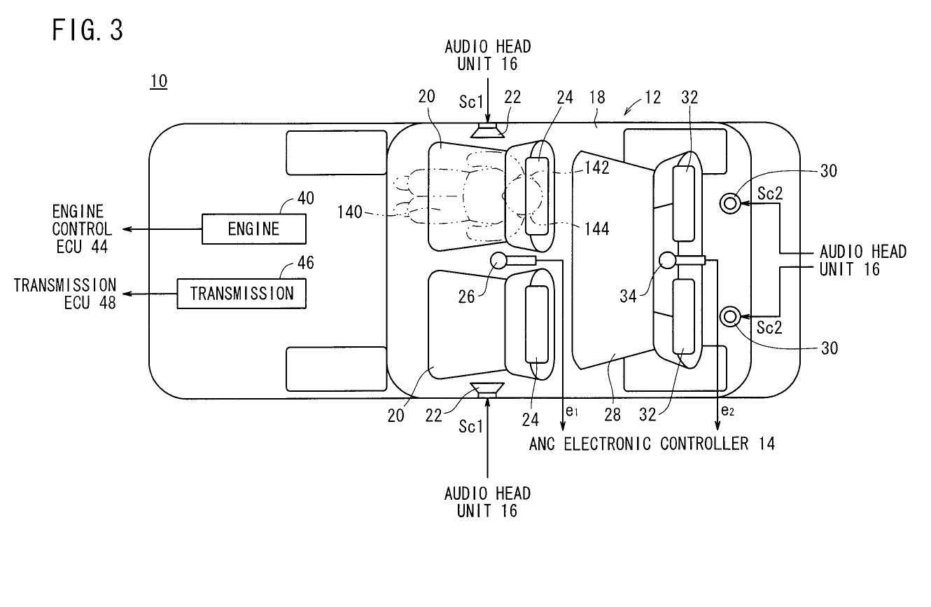

The reasons for silencing the in-compartment noise in the control mode B are as follows: As shown in FIG. 3, when frequencies of the sounds (the in-compartment noise and the canceling sounds) that enter the ears 142, 144 of the passenger 140 in the vehicle 18 become higher, and while the wavelengths thereof become shorter to a level close to the distance between the left and right speakers 22 near the front seats 20 and the microphone 26, different silencing capabilities for the in-compartment noise are developed at the positions of the ears 142, 144. As a result, the in-compartment noise at the position of the microphone 26 possibly may not be silenced by the canceling sounds from the speakers 22. Also, the in-compartment noise at the position of the microphone 34 possibly may not be silenced by the canceling sounds from the speakers 30. Consequently, as the frequencies of the above sounds become higher, the canceling sounds from the speakers 30 are detected by the microphone 26, while the canceling sounds from the speakers 22 are detected by the microphone 34, so that the distances from the speakers 22, 30 to the microphones 26, 34 are increased, thereby preventing the aforementioned different silencing capabilities from being developed.

The control mode C (see FIGS. 9 and 10) is employed if the in-compartment noise at the position of the microphone 34 can be reduced by canceling sounds from the speakers 22, for minimizing only the error signal e1 from the microphone 26, and the in-compartment noise at the position of the microphone 26 can be reduced by canceling sounds from the speakers 30, for minimizing only the error signal e2 from the microphone 34, without the need for silencing the in-compartment noise in the control mode A (see FIGS. 5 and 6). The control mode C requires and enables the microcomputer 60 to perform a smaller amount of calculations than the control mode A, because there is no need to take into account the canceling sound transfer paths based on the signal transfer characteristics C12 and C21.

In the control modes A through C, as shown in FIGS. 5 through 10, the canceling sound transfer paths, from the speakers 22, 30 to the microphones 26, 34 (the signal transfer characteristics C12 through C22), differ from each other. Also, the control signal generators 65a, 65b to which the error signals e1, e2 are input are different from each other. Therefore, in order to change the control modes A through C, the control characteristics changing unit 78 changes the connections of the switches 84, 98, and also changes the corrective values Ĉ1, Ĉ2 set in the reference signal generator 68a, 68b. Since the signal transfer characteristics C12 through C22 vary depending on the spatial configuration (i.e., four-door or two-door vehicle configuration) of the passenger compartment 18, the Ĉ column in the table shown in FIGS. 11 and 12 contains corrective values Ĉ for both four-door and two-door vehicles, depending on the control modes A through C.

As a consequence, in the control modes A through C, the corrective error signals e1′, e2′ input to the filter coefficient updating unit 76a, 76b, as well as the corrective values Ĉ1, Ĉ2 set in the reference signal generator 68a, 68b, are expressed in accordance with the following equations (7) through (12):

Control Mode A:

Ĉ1=Ĉ11+Ĉ12,

Ĉ2=Ĉ21+Ĉ22 (7)

Control Mode A:

e1′=e1″+h1=e1+e2+h1,

e2′=e2″+h2=e1+e2+h2 (8)

Control Mode B:

Ĉ1=Ĉ12, Ĉ2=Ĉ21 (9)

Control Mode B:

e1′=e1″+h1=e2+h1,

e2′=e2″+h2=e1+h2 (10)

Control Mode C:

Ĉ1=Ĉ11, Ĉ2=Ĉ22 (11)

Control Mode C:

e1′=e1″+h1=e1+h1,

e2′=e2″+h2=e2+h2 (12)

The specification information represents different combinations of various specifications (specification differences) of the vehicle 12 of one type, and is output from the ECUs 44, 48, 50 disposed in the vehicle 12 through a CAN, not shown, to the ANC electronic controller 14.

Specifically, as shown in FIGS. 1, 2, 11, and 12, the specification information includes (1) engine type signals (V6, L4 in the engine column in FIGS. 11 and 12) from the engine control ECU 44, representing engine types indicative of whether the engine 40 is a V6 engine or an L4 engine, (2) door type signals (four doors and two doors in the door column in FIGS. 11 and 12) from the door lock ECU 50, representing spatial configurations of the passenger compartment 18 indicative of whether the vehicle 12 is a four-door vehicle or a two-door vehicle, (3) active cylinder number signals (all cylinders, one disabled cylinder, and two disabled cylinders, in the cylinder column in FIGS. 11 and 12) from the engine control ECU 44, representing the number of active cylinders of the engine 40, (4) transmission type signals (AT and MT in the transmission column in FIGS. 11 and 12) from the transmission ECU 48 that controls the transmission 46 acting as a vibratory noise source, representing the type of transmission 46, i.e., a manual transmission (MT) or an automatic transmission (AT), and (5) drive type identification signals (2WD, 4WD in the 2WD/4WD column in FIGS. 11 and 12) from the engine control ECU 44, representing the drive type (i.e., a two-wheel drive type such as FF, FR, RR, or MR, or a four-wheel drive type such as 4WD) of the vehicle 12.

When the vehicle 12 is in operation, specification information is output from the ECUs 44, 48, 50 at predetermined time intervals to the ANC electronic controller 14. The control characteristics changing unit 78 has a buffer 130 therein for successively storing such specification information.

As shown in FIGS. 11 and 12, the EEPROM 80 (see FIG. 1) stores a number of control parameters depending on the specification information. The control characteristics changing unit 78 reads control parameters from the EEPROM 80, depending on some (e.g., an engine type signal and a door type signal) of the specification information acquired via the CAN, and thereafter monitors other specification information (e.g., an active cylinder number signal, a transmission type signal, and a drive type identification signal) acquired at predetermined time intervals, compares the present specification information acquired from the same ECUs with the preceding specification information stored in the buffer 130, and changes the control characteristics if there is a change between the present specification information and the preceding specification information.

Specifically, if there is a change between the present specification information and the preceding specification information, the control characteristics changing unit 78 outputs change signals Sm1 through Sm6, indicative of control parameters to be changed, to the basic signal generator 64, the reference signal generators 68a, 68b, the filter coefficient updating units 76a, 76b, the corrective signal generators 72a, 72b, the switches 84, 98, and the variable-gain amplifiers 88, 92, 94, 102.

The basic signal generator 64 changes the presently set frequency range of the basic signal x (the range of the control frequencies of the control signals y1, y2), along with the degree of the basic signal x with respect to the frequency of the engine rotation signal, to the frequency range and degree indicated by the change signal Sm1. The reference signal generators 68a, 68b change the presently set corrective values Ĉ1, Ĉ2 to the corrective values Ĉ1, Ĉ2 indicated by the change signal Sm2. The filter coefficient updating units 76a, 76b change the presently set step size parameters μ1, μ2 to the set step size parameters μ1, μ2 indicated by the change signal Sm3. The corrective signal generators 72a, 72b change the presently set constants α1, α2 to the constants α1, α2 indicated by the change signal Sm4. The switches 84, 98 change the presently set connections between the A/D converters 100a, 100b and the adders 75a, 75b to the connections indicated by the change signal Sm5. The variable-gain amplifiers 88, 92, 94, 102 change the presently set amplification factors to the amplification factors indicated by the change signal Sm6.

The ANC 10 according to the present embodiment is basically constructed as described above. Operation of the control characteristics changing unit 78 will be described below with reference to FIGS. 1 through 13.

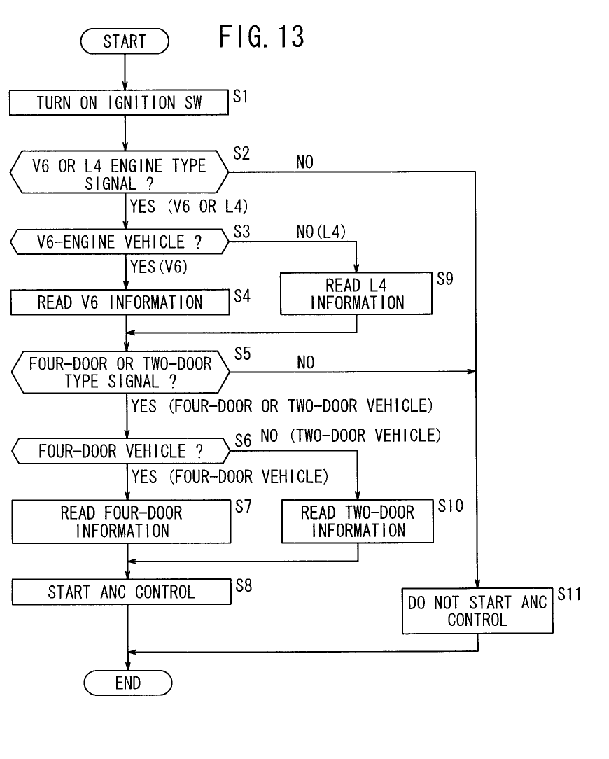

FIG. 13 is a flowchart of an operation sequence of the control characteristics changing unit 78, in which the passenger 140 (see FIG. 3) turns on an ignition switch, not shown, the control characteristics changing unit 78 changes various control parameters in the ANC electronic controller 14, and the ANC electronic controller 14 generates control signals y1, y2.

It is assumed that the control characteristics changing unit 78 acquires an engine type signal and a door type signal, reads various control parameters contained in the table shown in FIGS. 11 and 12 from the EEPROM 80, and changes the presently set control parameters in the ANC electronic controller 14 to the read control parameters, based on other specification information.

In step S1 shown in FIG. 13, the passenger 140 turns on the ignition switch. The ECUs 44, 48, 50 (see FIG. 2) in the vehicle 12 operate to output various signals indicative of specification information through the CAN to the control characteristics changing unit 78 (see FIG. 1).

In step S2, the control characteristics changing unit 78 determines whether the engine type signal acquired from the engine control ECU 44 is a signal indicative of a V6 engine or an L4 engine. If the engine type signal is a signal indicative of a V6 engine or an L4 engine, then the control characteristics changing unit 78 determines whether the signal is a signal indicative of a V6 engine in step S3.

If the control characteristics changing unit 78 judges that the engine type signal is a signal indicative of a V6 engine in step S3 (YES), then the control characteristics changing unit 78 decides to read control parameters depending on the specification information of the V6 engine from the EEPROM 80 in step S4. Then, the control characteristics changing unit 78 determines whether the door type signal acquired from the door lock ECU 50 is a signal indicative of a four-door vehicle or a two-door vehicle in step S5. If the control characteristics changing unit 78 judges that the door type signal is a signal indicative of a four-door vehicle or a two-door vehicle in step S5 (YES), then the control characteristics changing unit 78 determines whether the signal is a signal indicative of a four-door vehicle in step S6.

If the control characteristics changing unit 78 judges that the door type signal is a signal indicative of a four-door vehicle in step S6 (YES), then the control characteristics changing unit 78 decides to read control parameters depending on the specification information of the four-door vehicle from the EEPROM 80 in step S7.

In step S8, based on the decisions in steps S4 and S7, the control characteristics changing unit 78 reads control parameters (control parameters corresponding to the V6 engine and the four-door vehicle in FIG. 11) corresponding to the V6 engine and the four-door vehicle from the EEPROM 80. Also, based on the active cylinder number signal (all cylinders, one disabled cylinder, or two disabled cylinders) and the drive type identification signal (2WD or 4WD) from the engine ECU 44, and the transmission type signal (AT or MT) from the transmission ECU 48, the control characteristics changing unit 78 selects control parameters depending on the specification information from the read control parameters. Then, the control characteristics changing unit 78 outputs change signals Sm1 through Sm6, which represent the selected control parameters.

The basic signal generator 64 changes the presently set frequency range of the basic signal x and degree of the basic signal x with respect to the frequency of the engine rotation signal to the frequency range and degree indicated by the change signal Sm1. The reference signal generators 68a, 68b change the presently set corrective values Ĉ1, Ĉ2 to the corrective values Ĉ1, Ĉ2 indicated by the change signal Sm2. The filter coefficient updating units 76a, 76b change the presently set step size parameters μ1, μ2 to the set step size parameters μ1, μ2 indicated by the change signal Sm3. The corrective signal generators 72a, 72b change the presently set constants α1, α2 to the constants α1, α2 indicated by the change signal Sm4. The switches 84, 98 change the presently set connections between the A/D converters 100a, 100b and the adders 75a, 75b to the connections indicated by the change signal Sm5. The variable-gain amplifiers 88, 92, 94, 102 change the presently set amplification factors to the amplification factors indicated by the change signal Sm6. As a result, the ANC electronic controller 14 is made capable of generating the control signals y1, y2.

If the control characteristics changing unit 78 judges that the engine type signal is a signal indicative of an L4 engine in step S3 (NO), then in step S9 a decision is made in the control characteristics changing unit 78 to read control parameters from the EEPROM 80 depending on the specification information of the L4 engine. If the control characteristics changing unit 78 judges that the door type signal is a signal indicative of a two-door vehicle in step S6 (NO), then in step S10 a decision is made in the control characteristics changing unit 78 to read control parameters from the EEPROM 80 depending on the specification information of the two-door vehicle. As a result, based on the decisions made in steps S9 and S10, the control characteristics changing unit 78 reads control parameters (control parameters corresponding to the L4 engine and the two-door vehicle in FIG. 12) from the EEPROM 80 corresponding to the L4 engine and the two-door vehicle.

In step S8, the control characteristics changing unit 78 can read various control parameters from the EEPROM 80, based on the decisions in steps S4, S10 and the decisions in steps S9, S7.

If the control characteristics changing unit 78 judges that the engine type signal is not a signal indicative of a V6 engine or an L4 engine in step S2 (NO), or if the control characteristics changing unit 78 judges that the door type signal is not a signal indicative of a four-door vehicle or a two-door vehicle in step S5 (NO), then the control characteristics changing unit 78 does not read control parameters from the EEPROM 80, and outputs a change signal Sm3 to the filter coefficient updating units 76a, 76b, thereby instructing the updating units 76a, 76b to update the filter coefficients W1, W2 to nil. The filter coefficients W1, W2 of the adaptive filters 66a, 66b, 70a, 70b are now updated to W1=W2=0 by the filter coefficient updating unit 76a, 76b. As a consequence, the microcomputer 60 stops generating the control signals y1, y2, and the ANC 10 is placed in a state where it stops silencing the in-compartment noise in step S12.

With the ANC 10 according to the present embodiment, if several specification differences are available for a vehicle 12 of one type, then the control characteristics changing unit 78 changes the control characteristics (control parameters) depending on the specification information (type signals) acquired from the ECUs 44, 48, 50. Therefore, it is unnecessary to manufacture different ANCs 10 depending on the specification differences, or to change the control characteristics of the ANC 10 before the ANC is installed in the vehicle 12. Thus, the ANC 10 has greater versatility, can be prevented from being assembled erroneously on the vehicle 12, and can be managed with reduced man-hours and costs while preventing any deterioration in the control capability (silencing capability) thereof.

Even if the specification information is changed, the control characteristics can be changed depending on the changed specification information. Accordingly, the silencing control ability of the ANC 10 is stable, regardless of the specification differences. Specifically, if the specification information is information of low reliability, then the control characteristics may be changed in order to cause the ANC 10 to stop generating control signals y1, y2, or changed to cause the ANC 10 to operate with a lower silencing capability. Consequently, the ANC 10 has a failsafe design.

According to the present embodiment, therefore, even if the specification information is changed, the ANC 10 maintains an optimum silencing capability for the changed specification information.

Furthermore, even if the specification information is changed, the control characteristics changing unit 78 changes various control parameters, such as the frequency range of the basic signal x (the range of the control frequencies of the control signals y1, y2), the degree of the frequency of the basic signal x with respect to the frequency of the engine rotation signal, the corrective values Ĉ1, Ĉ2, and the step size parameters μ1, μ2, for optimum silencing capability. For example, when the control characteristics changing unit 78 changes the step size parameters μ1, μ2 depending on the changed specification information, the updating quantity μ1·e1′(n)·r1(n) for the filter coefficient W1 and the updating quantity μ2·e2′(n)·r2(n) for the filter coefficient W2, as indicated by the equations (3) and (4), can be optimized for efficiently lowering the in-compartment noise.

The corrective signals h1, h2 are estimated signals obtained by multiplying the quasi-control signals y1′, y2′ by the constants α1, α2. When the constants α1, α2 in equations (1), (2), (5) and (6) are changed depending on the specification information, it is possible to supply the filter coefficient updating unit 76a, 76b with corrective error signals e1′, e2′ that are optimum for updating the filter coefficients W1, W2, thereby optimizing the control signals y1, y2.

When the amplification factors of the variable-gain amplifiers 88, 92, 94, 102 are changed based on the specification information, control signals y1, y2 having optimum signal levels depending on the changed specification information can be supplied via the audio head unit 16 to the speakers 22, 30. Alternatively, error signals e having an optimum signal level can be supplied to the microcomputer 60. Accordingly, the silencing capability of the ANC 10 can be increased.

When the switches 84, 98 are controlled to change connections between the A/D converters 100a, 100b and the adders 75a, 75b based on the specification information, the in-compartment noise located about the ears 142, 144 of the passenger 140 can reliably be reduced, even if the specification information is changed.

When the control characteristics changing unit 78 acquires the specification information, it reads control characteristics corresponding to the acquired specification information from the EEPROM 80. Therefore, the control characteristics changing unit 78 can simply change the control characteristics, even if the specification information is changed.

The control characteristics changing unit 78 includes the buffer 130 for storing the specification information successively acquired from the ECUs 44, 48, 50. The control characteristics changing unit 78 compares the present specification information acquired from the ECUs 44, 48, 50 with the preceding specification information stored in the buffer 130. If there is a change between the present specification information and the preceding specification information, then the control characteristics changing unit 78 changes the control characteristics. Therefore, the control characteristics changing unit 78 can change the control characteristics more efficiently, even if the specification information is changed.

In the present embodiment, the ANC electronic controller 14 acquires specification information from the ECUs 44, 48, 50 via the CAN. However, the audio head unit 16 may be configured to hold specification information in advance, such that when signals depending on specification differences are input from the ECUs 44, 48, 50 to the audio head unit 16, the audio head unit 16 outputs stored specification information corresponding to the input signals to the ANC electronic controller 14.

Although certain preferred embodiments of the present invention have been shown and described in detail, it should be understood that various changes and modifications may be made therein without departing from the scope of the invention as set forth in the appended claims.

1. An active noise control apparatus comprising:
a control signal generator for generating a control signal for canceling out an in-compartment noise caused by a vibratory noise generated by a vibratory noise source in a vehicle, based on a frequency of said vibratory noise;
a sound outputting device for outputting a canceling sound based on said control signal into a passenger compartment of said vehicle; and
a sound detector for detecting a canceling error sound between said in-compartment noise and said canceling sound and outputting an error signal based on the detected canceling error sound to said control signal generator,
wherein said control signal generator comprises a control characteristics changing unit for acquiring specification information, concerning specifications of a spatial configuration of said passenger compartment and/or specifications of said vibratory noise source, from a plurality of electronic control units installed in said vehicle, and changing control characteristics of said control signal generator for generating said control signal to control characteristics corresponding to the acquired specification information.

2. An active noise control apparatus according to claim 1, wherein said control signal generator comprises:
a basic signal generator for generating a basic signal having a control frequency based on the frequency of said vibratory noise;
an adaptive filter for generating said control signal based on said basic signal;
a reference signal generator for correcting said basic signal based on a corrective value, depending on signal transfer characteristics from said sound outputting device to said sound detector, and outputting a corrected basic signal as a reference signal; and
a filter coefficient updating unit for updating a filter coefficient of said adaptive filter in order to minimize said error signal based on said error signal and said reference signal,
wherein, based on said specification information, said control characteristics changing unit changes at least one of a step size parameter for updating said filter coefficient, a range of said control frequency, and said corrective value.

3. An active noise control apparatus according to claim 2, wherein said control signal generator further comprises:
a corrective signal generator for generating a corrective signal by multiplying said reference signal by said filter coefficient and a predetermined constant; and
an adder for generating a corrective error signal by adding said corrective signal to said error signal, and outputting said corrective error signal to said filter coefficient updating unit,
wherein said filter coefficient updating unit updates the filter coefficient of said adaptive filter in order to minimize said corrective error signal based on said corrective error signal and said reference signal, and
wherein said control characteristics changing unit changes said constant based on said specification information.

4. An active noise control apparatus according to claim 2, wherein said control signal generator further comprises:
an error signal amplifier for amplifying said error signal from said sound detector and outputting the amplified error signal,
wherein said control characteristics changing unit changes an amplification factor of said error signal amplifier based on said specification information.

5. An active noise control apparatus according to claim 2, wherein said control signal generator further comprises:
a control signal amplifier for amplifying said control signal from said adaptive filter and outputting the amplified control signal to said sound outputting device,
wherein said control characteristics changing unit changes an amplification factor of said control signal amplifier based on said specification information.

6. An active noise control apparatus according to claim 2, wherein, if said basic signal generator generates said basic signal having said control frequency that is a harmonic of a predetermined degree with respect to the frequency of said vibratory noise, said control characteristics changing unit changes said degree based on said specification information.

7. An active noise control apparatus according to claim 1, wherein said sound detector comprises a plurality of sound detectors disposed in said passenger compartment, and said control signal generator comprises a switching unit for switching between said sound detectors for outputting said error signal,
wherein said control characteristics changing unit controls said switching unit based on said specification information to switch said sound detectors for outputting said error signal.

8. An active noise control apparatus according to claim 1, further comprising:
a control characteristics memory for storing in advance control characteristics corresponding to said specification information from said electronic control units,
wherein, when said control characteristics changing unit acquires said specification information, said control characteristics changing unit reads the control characteristics corresponding to the acquired specification information from said control characteristics memory, and changes the control characteristics set in said control signal generator to the read control characteristics.

9. An active noise control apparatus according to claim 1, wherein said control characteristics changing unit comprises a buffer for storing the specification information acquired from said electronic control units, and said control characteristics changing unit compares present specification information acquired from said electronic control units with preceding specification information stored in said buffer, and changes said control characteristics if there is a change between said present specification information and said preceding specification information.

10. An active noise control apparatus according to claim 1, wherein said vibratory noise source comprises an engine and/or a transmission.

11. An active noise control apparatus according to claim 1, wherein said sound outputting device outputs sounds into said passenger compartment based on a combined signal, which is a combination of said control signal and an audio signal generated by an audio head unit.

12. An active noise control apparatus according to claim 2, further comprising:
a signal transfer characteristics measuring device connected between an output terminal of said adaptive filter and an input terminal of said filter coefficient updating unit, for measuring said signal transfer characteristics based on a test signal output from said adaptive filter and a signal input to said filter coefficient updating unit,
wherein said signal transfer characteristics measured by said signal transfer characteristics measuring device are set as said corrective value in said control characteristics changing unit.

13. An active noise control apparatus according to claim 2, wherein said control characteristics changing unit controls said filter coefficient updating unit to stop generating said control signal if said control characteristics changing unit judges that information from said electronic control units is not said specification information.

14. An active noise control apparatus according to claim 3, wherein said control signal generator further comprises another adaptive filter which is identical in arrangement to said adaptive filter;
said other adaptive filter generates a signal by multiplying said reference signal by a filter coefficient thereof, and outputs the generated signal to said corrective signal generator; and
said corrective signal generator generates said corrective signal by multiplying said signal from said other adaptive filter by said constant.

15. An active noise control apparatus according to claim 7, wherein said sound outputting device comprises a plurality of sound outputting devices disposed in said passenger compartment;
one of said sound outputting devices is disposed near a front seat in said passenger compartment, and another one of said sound outputting devices is disposed near a rear seat in said passenger compartment; and
one of said sound detectors is disposed near the front seat in said passenger compartment, and another one of said sound detectors is disposed near the rear seat in said passenger compartment.

16. An active noise control apparatus according to claim 15, wherein, when said control signal is supplied to each of said sound outputting devices, each of said sound outputting devices outputs said canceling sound into said passenger compartment based on said control signal; and
each of said sound detectors detects a canceling error sound between the canceling sound from one of said sound outputting devices and said in-compartment noise, and outputs said error signal representing the detected canceling error sound to said control signal generator.

17. An active noise control apparatus according to claim 15, wherein, when said control signal is supplied to each of said sound outputting devices, each of said sound outputting devices outputs said canceling sound into said passenger compartment based on said control signal;
said one of the sound detectors, which is disposed near said front seat, detects a canceling error sound between the canceling sound from said other one of the sound outputting devices that is disposed near said rear seat and said in-compartment noise, and outputs said error signal representing the detected canceling error sound to said control signal generator; and
said other one of the sound detectors, which is disposed near said rear seat, detects a canceling error sound between the canceling sound from said one of the sound outputting devices that is disposed near said front seat and said in-compartment noise, and outputs said error signal representing the detected canceling error sound to said control signal generator.

18. An active noise control apparatus according to claim 15, wherein, when said control signal is supplied to each of said sound outputting devices, each of said sound outputting devices outputs said canceling sound into said passenger compartment based on said control signal;
said one of the sound detectors, which is disposed near said front seat, detects a canceling error sound between the canceling sound from said one of the sound outputting devices that is disposed near said front seat and said in-compartment noise, and outputs said error signal representing the detected canceling error sound to said control signal generator; and
said other one of the sound detectors, which is disposed near said rear seat, detects a canceling error sound between the canceling sound from said other one of the sound outputting devices that is disposed near said rear seat and said in-compartment noise, and outputs said error signal representing the detected canceling error sound to said control signal generator.
